(19) United States
(12) Patent Application Publication
(10) Pub. No.: US 2018/0242804 A1
(43) Pub. Date: Aug. 30, 2018

(54) DUST-REMOVAL APPARATUSES AND ASSOCIATED METHODS

(71) Applicant: Jingliang Pan, (US)

(72) Inventors: Jingliang Pan, Richmond (CA); Wei Yu, Suzhou (CN); Lu Gao, Suzhou (CN)

(21) Appl. No.: 15/621,799

(22) Filed: Jun. 13, 2017

(30) Foreign Application Priority Data
Feb. 27, 2017 (CN) 201710106956.3

(51) Int. Cl. A47L 9/16; B04C 5/185

(52) U.S. Cl. CPC A47L 9/1683; A47L 9/1666; B01D 50/002; A47L 9/165; B04C 5/185; A47L 9/1608

(57) ABSTRACT

Apparatuses for removing collected particles from a filter and associated methods are disclosed herein. In some embodiments, the apparatus includes (1) a housing having an air inlet and an air outlet and configured to form an airflow path entering the housing via the air inlet, flowing along an inner surface of the housing, and exiting the housing via the air outlet; (2) a filter positioned in the housing; (3) a propeller or impeller positioned adjacent to the filter and in the housing; (4) a driving component coupled to the propeller or impeller and configured to rotate the propeller or impeller; and (5) a plate structure positioned adjacent to the propeller or impeller and opposite to the driving component. The propeller or impeller can be configured to generate an airflow so as to facilitate collecting the particles traveling along the airflow path.

### RELATED APPLICATIONS

This patent document claims priority to the Chinese patent application no. CN201710106956.3 filed on Feb. 27, 2017. The entire contents of the before mentioned patent application is incorporated by reference in this patent document.

### TECHNICAL FIELD

The present technology is directed generally to apparatuses and associated methods for separating or removing dust, debris, or other particles from air or gas. More particularly, the present technology relates to a rotary cyclone apparatus for separating particles from air in a vacuum cleaner and/or removing collected dust or debris from a filter or screen positioned in a vacuum cleaner.

### BACKGROUND

A vacuum cleaner can draw air mixed with dust and then separate the dust from the air via cyclonic or vortex separation created by a degree of vacuum. If the degree of vacuum decreases, the centrifugal force of the cyclonic separation decreases, and thus the separation performance deteriorates. Typically the degree of vacuum is generated by a main motor of the vacuum cleaner. As the vacuum cleaner operates, fine dust or other particles typically accumulate on one or more filters of the vacuum cleaner. As the amount of the collected dust increases, the degree of vacuum generated by the main motor is reduced, which causes a decrease in air inlet rate, thereby reducing the efficiency and efficacy of the cyclonic separation or even leading to a total functional failure of the vacuum cleaner. Traditionally, when the filter is clogged, an operator needs to halt the cleaning process and then manually replace the filter or otherwise remove the collected dust. This is inefficient, time-consuming, and inconvenient to the operator. Therefore, it is advantageous to have an improved apparatus to address the above-mentioned problem.

### SUMMARY

The following summary is provided for the convenience of the reader and identifies several representative embodiments of the disclosed technology. Generally speaking, the present technology provides improved apparatuses and methods that enable a user to effectively remove dust or debris carried by air. More particularly, the present technology provides an apparatus configured to generate airflow to facilitate a cyclonic separation process (e.g., removing dust or debris by centrifugal forces created by a cyclonic airflow) performed by a vacuum cleaner having a housing. The generated airflow enhances the cyclonic separation process by moving the dust or debris toward an inner surface of the housing. In some embodiments, the generated airflow can also be directed toward the collected dust located on/in a filter (or a screen, sieve, other suitable separators, etc.) positioned in the housing, so as to remove or separate the collected dust from the filter. By this arrangement, an operator can control/manage the cyclonic separation process to effectively remove the dust or debris.

In representative embodiments, an apparatus for removing particles from air includes, for example, (1) a housing having an air inlet and an air outlet, the housing is configured to form an airflow path entering the housing via the air inlet, flowing along an inner surface of the housing, and exiting the housing via the air outlet; (2) a filter (or a screen, sieve, other suitable separators, etc.) positioned in the housing; (3) a propeller or impeller positioned adjacent to the filter and in the housing; (4) a driving component (e.g., a motor) coupled to the propeller or impeller and configured to rotate the propeller or impeller; and (5) a plate structure positioned adjacent to the propeller or impeller and opposite to the driving component. The plate structure has a first plate positioned adjacent to the propeller or impeller, a connecting component coupled to the first plate, and a second plate coupled to the connecting component and coupled to the housing. The propeller or impeller is configured to generate an airflow toward the filter in a cyclonic form so as to facilitate collecting the particles traveling along the airflow path.

Another aspect of the present technology is to provide a method for removing particles in air or other types of fluids. In some embodiments, the method includes (1) generating a primary airflow by a vacuum source; (2) directing the primary airflow to flow along an inner surface of a housing; (3) directing the primary airflow through a filter positioned in the housing; (4) collecting, by the filter, at least a portion of the particles carried by the primary airflow in a first direction; (5) in response to a status (e.g., whether there is a clog or not) of the filter or primary airflow, generating a secondary airflow at least partially in a second direction by a propeller or impeller positioned in the housing and internal to the filter; and (6) at least partially removing particles carried by the secondary airflow. In some embodiments, the first direction is generally parallel (e.g., together form an angle from 0 to 15 degrees) to the second direction.

Yet another aspect of the present technology is to provide an apparatus for removing particles carried by a primary airflow driven by a vacuum source. The apparatus includes (1) a housing at least partially defining a first chamber and a second chamber; (2) a propeller or impeller positioned in the first chamber; (3) a driving component coupled to the propeller or impeller and configured to rotate the propeller or impeller; (4) a filter circumferentially positioned external to the propeller or impeller and configured to at least partially guide the primary airflow and/or collect at least a portion of the particles carried by the primary airflow; and (5) a plate structure positioned adjacent to the propeller or impeller and opposite to the driving component. The primary airflow flows from the first chamber to the second chamber through the filter. The particles carried by the primary airflow are at least partially removed by a cyclonic separation process that is initiated, caused, sustained, reinforced, enhanced, or facilitated by a secondary airflow, generated by the propeller or impeller, at least partially in a second direction.

Apparatuses and methods in accordance with embodiments of the present technology can include any one or a combination of any of the foregoing elements described above.

### BRIEF DESCRIPTION OF THE DRAWINGS

FIG. 1 is an isometric view of an apparatus configured in accordance with representative embodiments of the disclosed technology.

FIG. 2 is a cross-sectional view of an apparatus configured in accordance with representative embodiments of the disclosed technology.

FIG. 3 is a top view illustrating a propeller or impeller configured in accordance with representative embodiments of the disclosed technology.

FIG. 4 is a cross-sectional view (line A-A) of the propeller or impeller shown in FIG. 3.

FIG. 5 is a flowchart illustrating a method in accordance with representative embodiments of the disclosed technology.

FIG. 6 is a schematic diagram illustrating a vacuum cleaning system having an apparatus configured in accordance with representative embodiments of the disclosed technology.

### DETAILED DESCRIPTION

### 1. Overview

The present technology is directed generally to apparatuses and associated methods for removing collected dust, debris, articles, and/or particles by (1) a cyclonic separation process and/or (2) a filtering process. In the cyclonic separation process, air carrying undesirable particles flows along an inner surface of a housing of the apparatus in a cyclonic air path such that at least a portion (e.g., the relatively heavy and/or large particles) of the carried particles can be separated from the air by centrifugal forces created by a cyclonic airflow (e.g., the carried particles are moved radially toward the inner surface of the housing). The present technology enables an operator to generate an airflow to enhance the overall efficiency of the cyclonic separation process.

The apparatus can include a filter configured to filter the air carrying undesirable particles. During the filtering process, the air carrying undesirable particles (e.g., relatively light and/or small particles that are not removed by the cyclonic separation process) passes through the filter and then the undesirable particles are collected or screened out by the filter. When the number of the collected particles increases, the efficiency of the filtering process decreases (e.g., at least because it becomes harder for air to pass through). The present technology enables an operator to effectively remove at least a portion of the collected particles from the filter so as to enhance the overall efficiency of the filtering process.

The present technology can provide a propeller or impeller (e.g., driven by a motor) positioned adjacent to the filter that can collect undesirable particles. In some embodiments, the filter can have a circumferential or an annular structure (e.g., a partial or truncated conical shape). In such embodiments, the propeller or impeller can be positioned internal to the filter (e.g., the filter circumferentially surrounds the propeller or impeller). The propeller or impeller can be configured to initiate, create, sustain, facilitate, and/or enhance the cyclonic separation process mentioned above. For example, when a primary airflow driving by a vacuum source flows along the cyclonic air path, the propeller or impeller can generate a secondary airflow to enhance, reinforce, or otherwise facilitate the cyclonic separation process of the primary airflow. In some embodiments, the primary airflow may not necessarily be adequate (e.g., due to a weak vacuum source, clogged filter(s) and/or air pathway(s), certain position and/or orientation of air inlets/outlets with respect to a housing, etc.) to establish the cyclonic air path. In these embodiments, the propeller or impeller can generate the secondary airflow as a primary force that drives the cyclonic separation process. In some embodiments, the secondary airflow can also facilitate the filtering process. For example, when the primary airflow passes the filter, the undesirable particles carried by the primary airflow can be stopped and collected by the filter. The collected particles can then be removed or blown away by the secondary airflow generated by the propeller or impeller. The secondary airflow can also move (e.g., downwardly) the collected particles to a lower portion of a dust chamber of the apparatus, for the convenience of gathering and discarding the collected particles. The present technology can also provide a plate structure to prevent the removed collected particles from bouncing or moving back toward the filter or to an upper portion of the dust chamber.

In some embodiments, the secondary airflow can be generated without substantially interfering with the primary airflow. For example, the primary airflow controls the rate or volume of air passing through the housing of the apparatus, and the secondary airflow initiates, creates, sustains, enhances, and/or facilitates a cyclonic separation process that may or may not be caused by the primary airflow. In addition, the secondary airflow does not substantially hinder the filtering efficiency of the filter, either. In some embodiments, when the filtering efficiency of the filter is lower than a threshold value (e.g., the pressure drop of the filter is higher than a pressure-drop threshold value, which may suggest that there are too many collected particles on/in the filter), the present technology can generate the secondary airflow to effectively remove the collected particles. For example, the secondary airflow can be generated at various flow rates and/or cyclonic directions to cause impulse(s) or other suitable forms of force to facilitate removal of the collected particles.

In some embodiments, the primary airflow can be adjusted (e.g., lower its flow rate) when the secondary airflow is generated. In some embodiments, the present technology can monitor the status (e.g., flow rate) of the primary airflow and then determine when to initiate a process of generating the secondary airflow and/or adjust the rate or strength of the second airflow based on the monitored status.

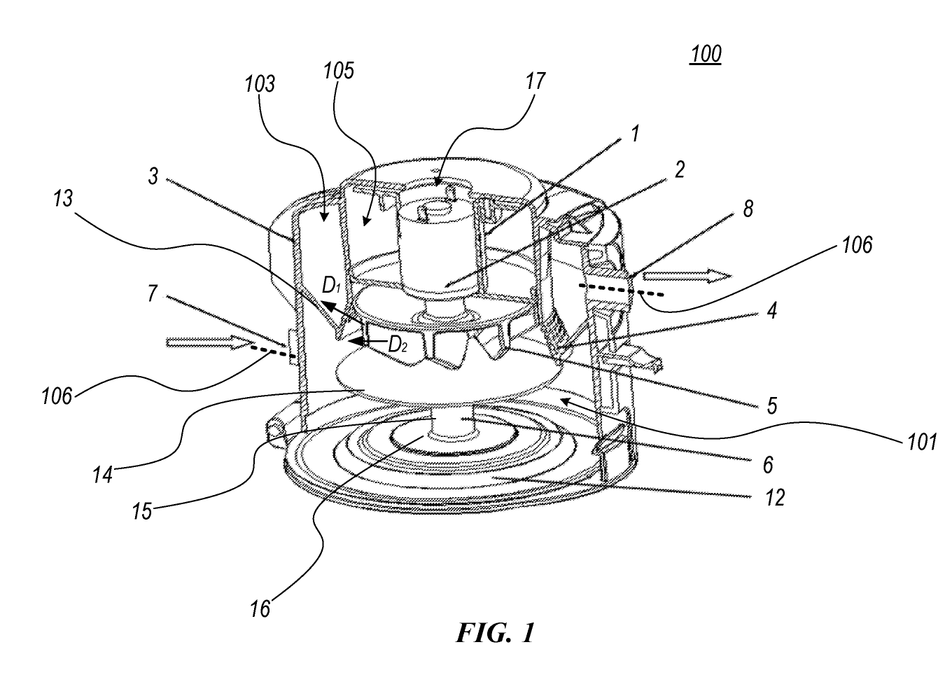

Several details describing structures or processes that are well-known and often associated with heat-press apparatuses and corresponding systems and subsystems, but that may unnecessarily obscure some significant aspects of the disclosed technology, are not set forth in the following description for purposes of clarity. Moreover, although the following disclosure sets forth several embodiments of different aspects of the technology, several other embodiments can have different configurations and/or different components than those described in this section. Accordingly, the technology may have other embodiments with additional elements and/or without several of the elements described below with reference to FIGS. 1-6. FIGS. 1-6 are provided to illustrate representative embodiments of the disclosed technology. Unless provided for otherwise, the drawings are not intended to limit the scope of the claims in the present application.

### 2. Representative Embodiments

FIG. 1 is an isometric view of an apparatus 100 (some components shown in cross section) configured in accordance with representative embodiments of the disclosed technology. The apparatus 100 includes a housing 3 (shown in cross section), a driving component 2, a chassis 1 configured to support the driving component 2, a propeller or impeller 5 coupled to the driving component 2, a filter (or a screen, sieve, other suitable separators, etc.) 4 coupled to the housing 3, a dividing plate 13 coupled to the housing 3 and the filter 4, a plate structure 6 positioned in the housing 3, and a lower cover 12 operably coupled to the housing 3. As shown, the housing 3 includes an air inlet 7 and an air outlet 8. The outlet 8 can be coupled to a vacuum source (not shown). The inlet 7 can be coupled to a cleaning suction nozzle or wand (not shown) and configured to receive air carrying dust or particles. The vacuum source can generate a primary (or first) airflow that enters the apparatus 100 via the inlet 7, passes through the filter 4, and then exits the apparatus 100 via the outlet 8. At least a portion of the dust or particles carried by the primary airflow can be screened out by the filter 4. In other embodiments, the primary airflow can be generated or driven by an air mover coupled to the inlet 7.

As shown in FIG. 1, the housing 3 defines a first chamber 101, a second chamber 103, and a third chamber 105. The propeller or impeller 5 and the plate structure 6 are positioned in the first chamber 101. The filter 4 is positioned between the first chamber 101 and the second chamber 103. The driving component 2 is positioned in the third chamber 105 (e.g., supported the chassis 1).

In the illustrated embodiments, the housing 3 has an opening 17 configured to enable a user to install, maintain, and/or replace the driving component 2. In some embodiments, the apparatus 100 can include one or more connecting points positioned in/on the housing 3 and configured to electrically couple the driving component 2 to a power source (e.g., a battery).

The air carrying dust/particles follows a beginning section of an air path 106 and enters into the first chamber 101 via the inlet 7. The air can then flow along a cyclonic section (not shown) of the air path 106 formed by an inner surface of the housing 3. Due to centrifugal forces, a portion of the carried particles (e.g., relatively heavy and/or large particles) can be moved radially toward and contact the inner surface of the housing 3. The particles can then be moved toward the lower cover (e.g., by gravity and/or airflow) and be removed from the apparatus 100 (e.g., an operator can open the lower cover 12 and remove the particles when the apparatus 100 is not operating). The air can then follow another section (not shown) of the air path 106 and flow toward the filter 4, where the remaining dust/particles (e.g., relatively light and/or small particles) carried by the air can be further filtered or collected. In some embodiments, at least a portion of the remaining dust/particles hit the inner surface of the filter 4 (e.g., solid surface area between or among holes or other perforations on the filter 4) due to the centrifugal forces, then travel toward the lower cover (e.g., by gravity and/or airflow) without being collected on the filter 4, and are thus separated from the air. The filtered air can then follow yet another section (not shown) of the air path 106 and move into the second chamber 103 in a first direction D₁, and follow an ending section of the air path 106 to exit the apparatus 100 via the outlet 8. In some embodiments, the particles collected on filter 4 can negatively affect the filtering efficiency of the filter 4.

In some embodiments, to remove or separate the collected particles from the filter 4, the driving component 2 can rotate the propeller or impeller 4 to generate a secondary (or second) airflow. In the illustrated embodiments, the secondary airflow can be generated in a cyclonic or rotary form while pushing toward a second direction D₂. The secondary airflow can remove at least a portion of the collected particles. The removed particles can then be moved toward the lower cover 12 (e.g., as pushed by the secondary air flow and/or by gravity). The removed particles can then be further removed from the apparatus 100. In some embodiments, the secondary airflow can initiate, create, sustain, enhance and/or facilitate the cyclonic separation process by providing primary or additional centrifugal forces to the carried particles (e.g., forcing the particles toward the inner surface of the housing 3).

The plate structure 6 can be configured to prevent the particles located in the lower portion (e.g., close to the lower cover 12) from moving or bouncing up to the filter 4. The plate structure 6 includes an upper plate 14, a connecting component 15 coupled to the upper plate 14, and a lower plate 16 coupled to the connecting component 15. In the illustrated embodiments, the lower plate 16 is coupled to the lower cover 12. In some embodiments, the lower plate 16 and the lower cover 12 can be integrally formed. In the illustrated embodiments, the upper plate 14 can have a first size greater than a second size of the lower plate 16. In some embodiments, the first size and/or shape of the upper plate 14 can be determined at least based in part on the size and/or shape of the filter 4. In some embodiments, a user or vendor of the apparatus 100 can adjust the size and/or shape of the upper plate 14 based on user preferences, operating conditions, performance requirements, or the like. In some embodiments, the user or vendor can adjust the distance between the filter 4 and the upper plate 14 based on user preferences, operating conditions, performance requirements, or the like, by using connecting components 15 with different lengths or sizes.

In some embodiments, the lower plate 16 can include multiple plates with different sizes (e.g., determined by the size and/or shape of the lower cover 12). The multiple-plate arrangement can facilitate dust/particle collection. For example, this arrangement can facilitate keeping the dust/particles closer to the outer peripheral section of the lower cover 12. When the lower cover opens, the dust/particles can be readily removed from the apparatus 100.

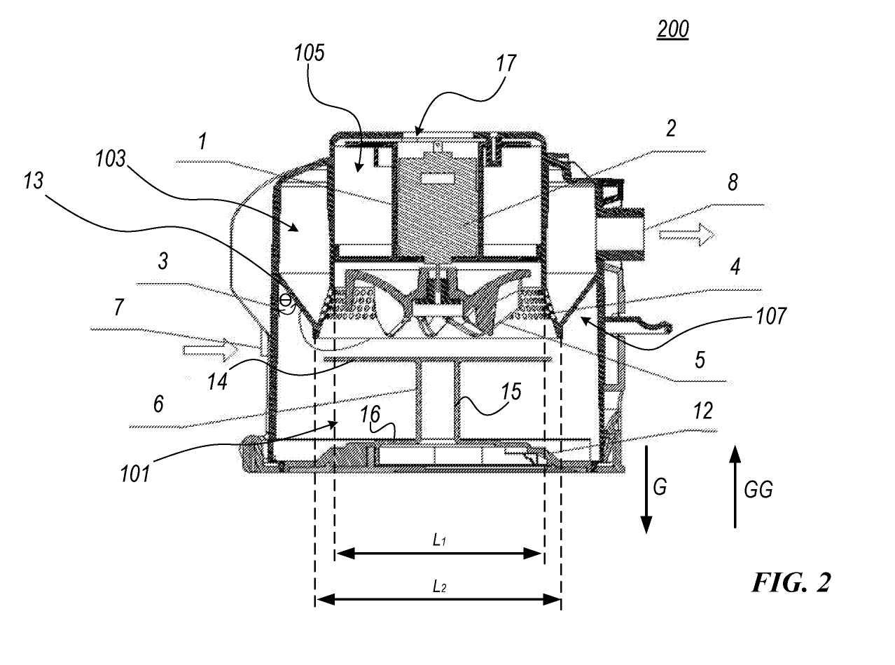

FIG. 2 is a cross-sectional view of the apparatus 100 configured in accordance with representative embodiments of the disclosed technology. As shown in FIG. 2, the filter 4 has a partial or truncated conical shape. In the illustrated embodiments, the filter 4 has an upper diameter L₁ and a lower diameter L₂ greater than the upper diameter L₁. In this configuration, gravity (as indicated by arrow G) can facilitate the particles collected by the filter 4 to move toward the lower cover 12.

As shown in FIG. 2, the dividing plate 13 and the housing 3 can together form an angle θ. In the illustrated embodiments, the angle e is an acute angle (e.g., 30-60 degrees). The dividing plate 13 and the housing 3 can together define a collection area 107. In some embodiments, when the air carrying particles hits the inner surface of the housing 3, a portion of the air may move upwardly toward the collection area 107. The air can then be “trapped” in the collection area 107 (e.g., by turbulence or eddies in the collection area 107) and then the particles can be moved from the air when they contact the housing 3.

In some embodiments, the apparatus 100 can be operated in various orientations. For example, when the apparatus 100 is operated in an “upside-down” orientation, gravity is in direction GG shown in FIG. 2. In such embodiments, the collection area 107 can be configured to collect at least a portion of separated particles. Once the apparatus 100 rotates back to a normal position (e.g., in which cases gravity is in direction G shown in FIG. 2), the particles in the collection area 107 can be moved toward the lower cover 12 by gravity and then be removed from the apparatus 100.

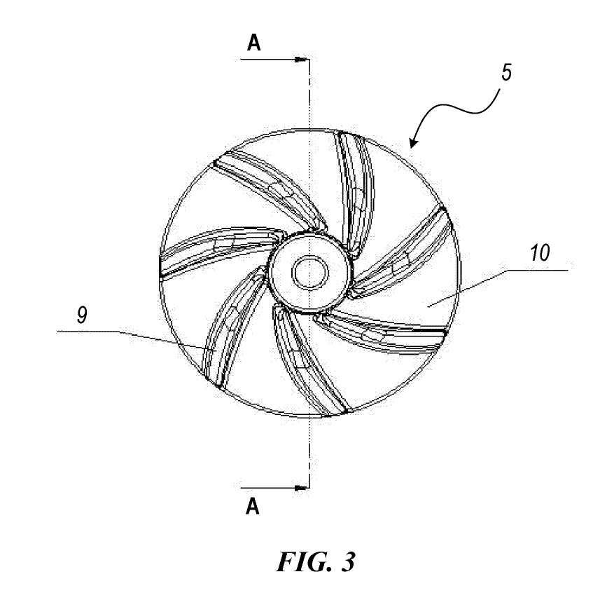

FIG. 3 is a top view illustrating a propeller or impeller 5 configured in accordance with representative embodiments of the disclosed technology. As shown, the propeller or impeller 5 includes a supporting plate 10 and seven blades 9 positioned on the supporting plate 10. As shown, the blades 9 are circumferentially and radially positioned on the supporting plate 10 such that when the propeller or impeller 5 rotates, the blades 9 can generate the secondary airflow to initiate, create, sustain, enhance, or facilitate a cyclonic separation process and/or to remove the collected particles from the filter 4, as mentioned above. In some embodiments, the number or shape of the blades 9 can vary depending on different designs or be adjusted due to aerodynamic considerations. In some embodiments, the sizes and locations of the blades 9 can vary depending on various design needs.

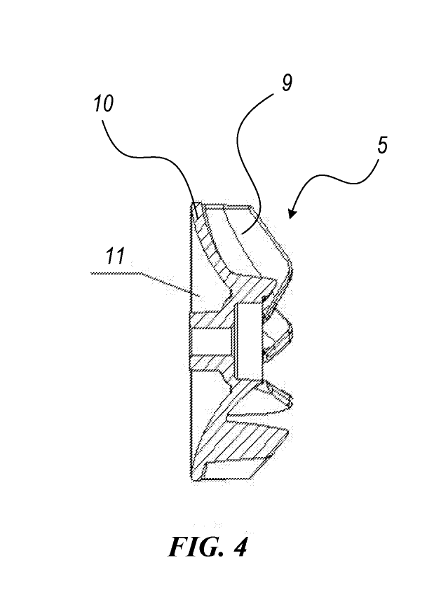

FIG. 4 is a cross-sectional view (line A-A) of the propeller or impeller 5 shown in FIG. 3. As shown, the supporting plate 10 can be formed with a recess 11 on the side opposite to the blades 9. Such configuration can reduce the weight of the supporting plate 10 while maintaining sufficient structural rigidity of the supporting plate 10 to perform relevant tasks (e.g., to generate the secondary airflow).

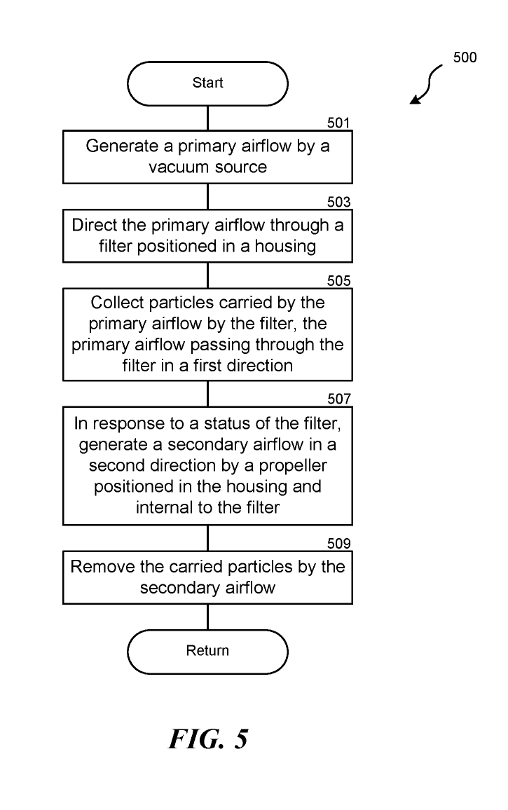

FIG. 5 is a flowchart illustrating a method 500 in accordance with representative embodiments of the disclosed technology. The method 500 can be implemented by the apparatuses (e.g., the apparatus 100) in accordance with the present technology. The method 500 can effectively remove undesirable particles in air or other fluid. At block 501, the method 500 starts by generating a primary airflow by a vacuum source. In other embodiments, the primary airflow can be generated by an air mover or other suitable devices. In some embodiments, the method 500 can include directing the primary airflow to flow along an inner surface of a housing of the apparatus (e.g., along a cyclonic path close to the inner surface of housing 3 of the apparatus 100). The primary airflow may or may not cause cyclonic separation of particles from the air within the housing.

At block 503, the method 500 continues by directing the primary airflow through a filter positioned in the housing. At block 505, the method 500 includes collecting, by the filter, at least a portion of particles carried by the primary airflow. The primary airflow passes through the filter in a first direction (e.g., D₁ shown in FIG. 1). In some embodiments, the filter is configured or functions to guide the airflow without collecting undesired particles.

At block 507, in response to a status of the filter and/or a status of the primary airflow, a secondary airflow is generated in a second direction (e.g., a rotary or cyclonic airflow that also pushes toward direction D₂ shown in FIG. 1). The secondary airflow can cause or initiate a cyclonic separation of particles from the air within the housing, or reinforce or enhance a cyclonic separation process that was already caused or initiated by the primary airflow. Examples of the filter status include the filtering efficiency of the filter, a pressure drop of the filter, temperature of the driving component, and/or other suitable statuses of the filter or other components. Examples of the primary airflow status include a decrease or fluctuation of airflow rate, efficiency of one or more other filters within the overall vacuum cleaner or device, status of one or more air ducts related to the primary airflow, status of the vacuum source that drives or causes the primary airflow, and/or other suitable statuses related to the primary airflow. In some embodiments, the secondary airflow can be generated by a propeller or impeller (e.g., propeller or impeller 5 shown in FIGS. 1-4) positioned in the housing and internal to the filter. In some embodiments, the secondary airflow can be generated regardless of the status of the filter or the primary airflow. In some embodiments, the secondary airflow can be generated before or simultaneously with the generation of the primary airflow (e.g., to initiate and/or sustain a cyclonic separation process within the housing). In some embodiments, the secondary airflow can be generated after the primary airflow is paused or terminated (e.g., in order to dislodge particles collected on the filter without interference or resistance caused by the primary airflow). In some embodiments, the secondary airflow can be generated in response to a user request and/or independent of the generation of the primary airflow. At block 509, the method 500 proceeds by at least partially removing the particles carried by the secondary airflow (e.g., via a cyclonic separation process where the particles may hit the inner surface of the filter or housing due to centrifugal force). The method 500 then returns and waits for further instructions.

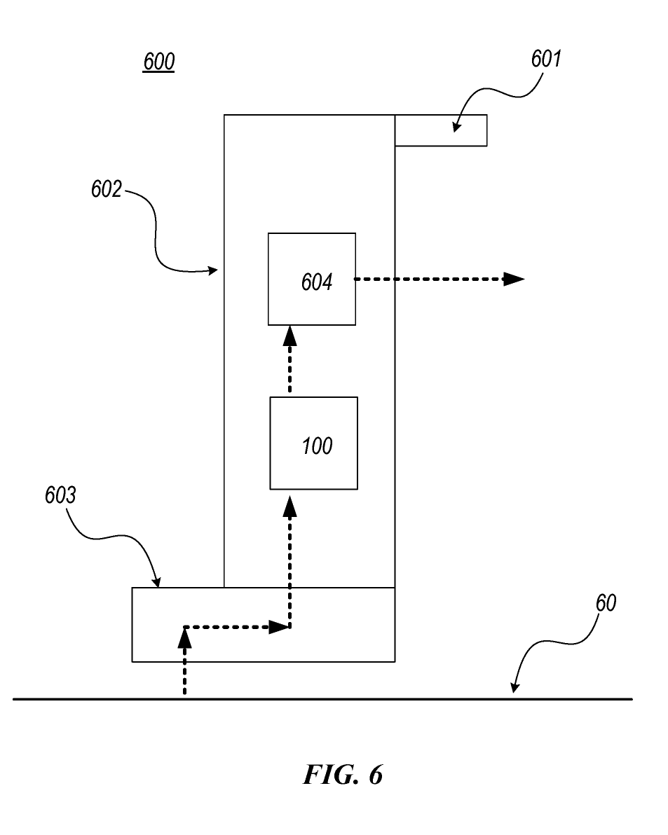

FIG. 6 is a schematic diagram illustrating a vacuum cleaning system 600 having the apparatus 100 configured in accordance with representative embodiments of the disclosed technology. The system 600 includes a handle 601 configured to enable a user to operate the system 600, a main body 602 coupled to the handle 601, and a nozzle 603 coupled to the main body 602 and configured to draw air from a surface 60 (e.g., a floor surface or other surface to be cleaned). The main body 602 includes a vacuum source 604 (e.g., driven by a main motor of the vacuum cleaning system 600) and the apparatus 100 positioned therein. The vacuum source 604 and the apparatus 100 are in fluid communication. The vacuum source 604 draws air from the nozzle 603 to the apparatus 100 such that dust or debris carried by the drawn air can be collected by the apparatus 100 (as described above with reference to FIGS. 1 and 2). Then the drawn air can be discharged from the system 600. The dotted lines shown in FIG. 6 indicate embodiments of the air flow path passing through the system 600.

From the foregoing, it will be appreciated that specific embodiments of the technology have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall with within the scope of the present technology. Accordingly, the present disclosure and associated technology can encompass other embodiments not expressly shown or described herein.

I/we claim:

1. An apparatus for removing particles carried by a primary airflow driven by a vacuum source, the apparatus comprising:
a housing at least partially defining a first chamber and a second chamber, the primary airflow flows from the first chamber to the second chamber;
a group of blades positioned in the first chamber;
a driving component coupled to the group of blades and configured to rotate the group of blades;
a filter circumferentially positioned external to the group of blades and configured to collect at least a first portion of particles carried by the primary airflow, the filter being positioned between the first chamber and the second chamber; and
a plate structure positioned adjacent to the group of blades and opposite to the driving component;
wherein at least a second portion of particles carried by the primary airflow are separated from the primary airflow within the first chamber; and
wherein the group of blades is configured to generate a secondary airflow to facilitate the separation of the at least a second portion of particles.

2. The apparatus of claim 1, wherein the at least a second portion of particles are separated in accordance with a cyclonic separation process.

3. The apparatus of claim 1, further comprising a dividing plate configured to separate the first chamber and the second chamber.

4. The apparatus of claim 3, wherein the dividing plate is coupled to the filter and positioned external to the filter.

5. The apparatus of claim 3, wherein the dividing plate and the housing together define an acute angle.

6. The apparatus of claim 1, further comprising a chassis configured to support the driving component, wherein the chassis and the driving component are positioned in a third chamber defined by the housing.

7. The apparatus of claim 6, wherein the second chamber is circumferentially positioned external to the third chamber.

8. The apparatus of claim 1, wherein the driving component includes a motor.

9. The apparatus of claim 1, wherein the group of blades has a first side and a second side opposite to the first side, and wherein a recess is formed on the first side, and wherein the first side is positioned adjacent to the driving component.

10. The apparatus of claim 9, wherein the second side of the group of blades is positioned adjacent to the plate structure.

11. The apparatus of claim 1, wherein the plate structure includes an upper plate and a connecting component coupled to the upper plate.

12. The apparatus of claim 11, wherein the plate structure further includes a lower plate coupled to the connecting component and a lower cover, and wherein the lower cover is operably coupled to the housing.

13. The apparatus of claim 11, wherein the upper plate is positioned adjacent to the group of blades.

14. The apparatus of claim 12, wherein the lower plate is coupled to the housing.

15. The apparatus of claim 1, wherein the filter has a partially conical shape.

16. A method for removing particles in air, the method comprising:
generating a primary airflow by a vacuum source;
directing the primary airflow to flow along an inner surface of a housing;
directing the primary airflow through a filter positioned in the housing, the primary airflow passing through the filter in a first direction;
in response to at least one of a status of the filter or a status of the primary airflow, generating a secondary airflow at least partially in a second direction by a propeller positioned in the housing; and
at least partially removing particles carried by the first or secondary airflow.

17. The method of claim 16, further comprising preventing the removed particles from moving back to the filter by a plate structure positioned in the housing and adjacent to the propeller.

18. The method of claim 17, further comprising driving the propeller or impeller to generate the secondary airflow by a motor coupled to the propeller and positioned opposite to the plate structure.

19. The method of claim 16, wherein the first direction is generally parallel to the second direction.

20. An apparatus for removing particles carried by air, the apparatus comprising:
a housing having an air inlet and an air outlet, the housing is configured to form an airflow path entering the housing via the air inlet, flowing along an inner surface of the housing, and exiting the housing via the air outlet;
a group of blades positioned in the housing;
a driving component coupled to the group of blades and configured to rotate the group of blades; and
a plate structure positioned adjacent to the group of blades and opposite to the driving component;
wherein the group of blades is configured to generate an airflow so as to facilitate collecting the particles traveling along the airflow path.
